(19) United States
(12) Patent Application Publication
(10) Pub. No.: US 2024/0097266 A1
(43) Pub. Date: Mar. 21, 2024

(54) BATTERY ASSEMBLY AND METHOD THEREFOR

(71) Applicant: GM GLOBAL TECHNOLOGY OPERATIONS LLC, Detroit, MI (US)

(72) Inventors: SriLakshmi Katar, Troy, MI (US); Andrew P. Oury, Troy, MI (US); Taylor R. Garrick, Bloomfield Hills, MI (US); Liang Xi, Northville, MI (US); Kuber Mishra, Toledo, OH (US); Kavi Loganathan, Brookfield, WI (US)

(73) Assignee: GM GLOBAL TECHNOLOGY OPERATIONS LLC, Detroit, MI (US)

(21) Appl. No.: 17/945,607

(22) Filed: Sep. 15, 2022

(51) Int. Cl. H01M 50/289; H01M 50/209; H01M 50/211; H01M 50/512; H01M 50/534

(52) U.S. Cl. CPC H01M 50/289; H01M 50/209; H01M 50/211; H01M 50/512; H01M 50/534

(57) ABSTRACT

A battery assembly includes a first plurality of battery cells, a second plurality of battery cells, and an intermediate layer arranged in a stack. Each of the first plurality of battery cells includes a first cathode, a first cathode current collector, a first anode, a first anode current collector, and a first solid state separator, and each of the second plurality of battery cells includes a second cathode, a second cathode current collector, a second anode, a second anode current collector, and a second solid state separator. The first cathode current collectors are electrically connected in parallel to a first terminal, and the second anode current collectors are electrically connected in parallel to a second terminal. The first anode current collectors of the first plurality of battery cells are electrically connected and are electrically connected to the second cathode current collectors of the second plurality of battery cells.

### INTRODUCTION

The concepts described herein relate to arrangements of battery cells into battery assemblies.

### SUMMARY

The concepts herein provide a battery assembly and associated method of assembly that may increase energy density and specific energy through the use of internal cell connections. The battery assembly may raise the cell potential without exceeding a local potential difference between an anode/cathode pair that may otherwise result in localized overcharging. The internal cell connection is designed to facilitate lower heat generation compared to comparable external cell series connections.

An aspect of the disclosure includes a battery assembly having a first plurality of battery cells, a second plurality of battery cells, and an intermediate layer arranged in a stack. The intermediate layer is interposed between the first plurality of battery cells and the second plurality of battery cells. Each of the first plurality of battery cells includes a first cathode, a first cathode current collector, a first anode, a first anode current collector, and a first solid state separator, and each of the second plurality of battery cells includes a second cathode, a second cathode current collector, a second anode, a second anode current collector, and a second solid state separator. The first cathode current collectors of the first plurality of battery cells are electrically connected in parallel to a first terminal, and the second anode current collectors of the second plurality of battery cells are electrically connected in parallel to a second terminal. The first anode current collectors of the first plurality of battery cells are electrically connected and are electrically connected to the second cathode current collectors of the second plurality of battery cells.

Another aspect of the disclosure may include the intermediate layer ionically and electronically isolating the first plurality of battery cells from the second plurality of battery cells.

Another aspect of the disclosure may include the intermediate layer overlaying the first plurality of battery cells and the second plurality of battery cells.

Another aspect of the disclosure may include the intermediate layer having a surface area that is greater than a corresponding surface area of both the first plurality of battery cells and the second plurality of battery cells.

Another aspect of the disclosure may include the first plurality of battery cells and the second plurality of battery cells being pouch cells.

Another aspect of the disclosure may include the first plurality of battery cells and the second plurality of battery cells being prismatic cells.

Another aspect of the disclosure may include each of the first battery cells further having a solid state electrolyte arranged between the first cathode and the first anode, and wherein each of the second battery cells further includes a solid state electrolyte arranged between the second cathode and the second anode.

Another aspect of the disclosure may include the solid state separator being arranged between adjacent cells of the first plurality of battery cells.

Another aspect of the disclosure may include the solid state separator being arranged between adjacent cells of the second plurality of battery cells.

Another aspect of the disclosure may include the first anode current collectors being tab portions, wherein the first anode current collectors are electrically connected via the tab portions.

Another aspect of the disclosure may include the tab portions being coated.

Another aspect of the disclosure may include an enclosure, wherein the plurality of battery cells and the intermediate layer arranged in the stack are contained within the enclosure.

Another aspect of the disclosure may include a battery assembly that includes a plurality of battery cells and an intermediate layer arranged in a stack and disposed within an enclosure. Each of the plurality of battery cells includes a cathode, a cathode current collector, an anode, an anode current collector, and a solid state separator including a solid state electrolyte. The plurality of battery cells includes a first subset and a second subset, wherein the intermediate layer is an overlayment that is interposed between the first subset and the second subset. Each of the battery cells of the first subset includes a first cathode, a first cathode current collector, a first anode, a first anode current collector, and a first solid state separator, and each of the battery cells of the second subset includes a second cathode, a second cathode current collector, a second anode, a second anode current collector, and a second solid state separator. The first cathode current collectors of the first subset are electrically connected in parallel to a first terminal. The second anode current collectors of the second subset are electrically connected in parallel to a second terminal. The first anode current collectors of the first subset are electrically connected together and are electrically connected to the second cathode current collectors of the second subset.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a three-dimensional isometric view of a battery assembly that is composed of a plurality of battery cells, in accordance with the disclosure.

FIG. 2 schematically illustrates a top view of a single battery cell including an anode and a cathode, in accordance with the disclosure.

FIG. 3 schematically illustrates a cutaway end view of a battery assembly that is composed of a plurality of battery cells, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be employed to assist in describing the drawings. These and similar directional terms are illustrative, and are not to be construed to limit the scope of the disclosure. Furthermore, the disclosure, as illustrated and described herein, may be practiced in the absence of an element that is not specifically disclosed herein.

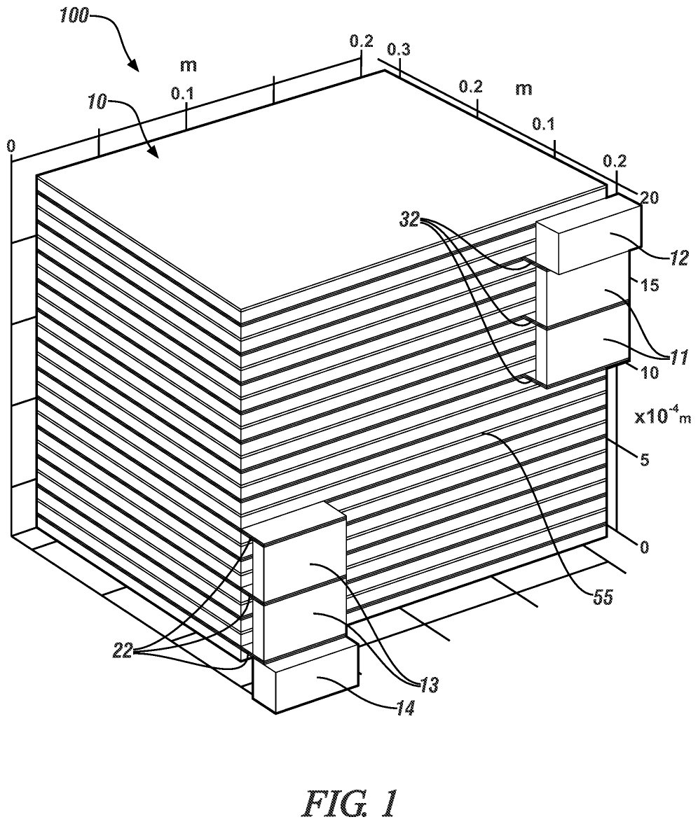

Referring to the drawings, wherein like reference numerals correspond to like or similar components throughout the several Figures, FIGS. 1, 2 and 3 schematically illustrate elements of an embodiment of a battery assembly 100 that is composed of a plurality of battery cells 10 that are arranged in a manner described herein. The terms “anode” and “negative electrode” are used interchangeably. The terms “cathode” and “positive electrode” are used interchangeably.

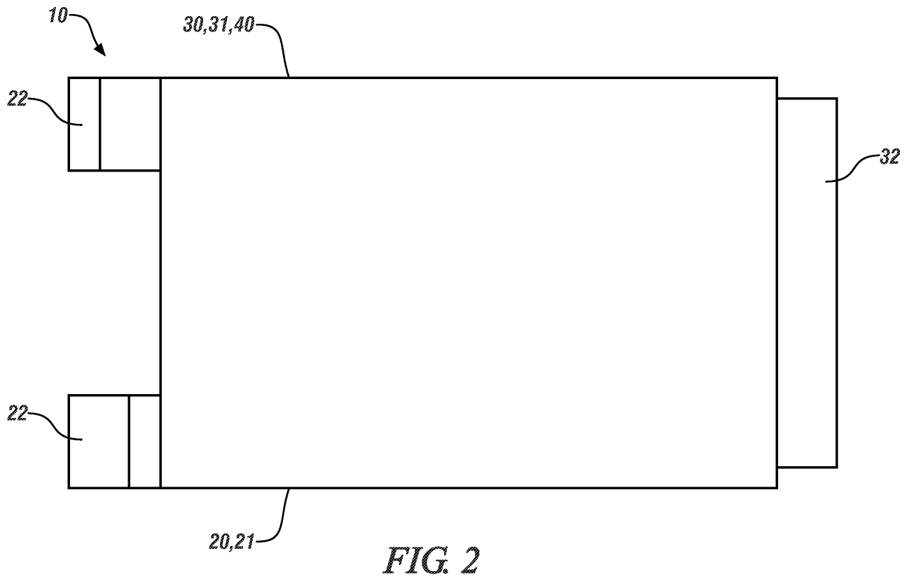

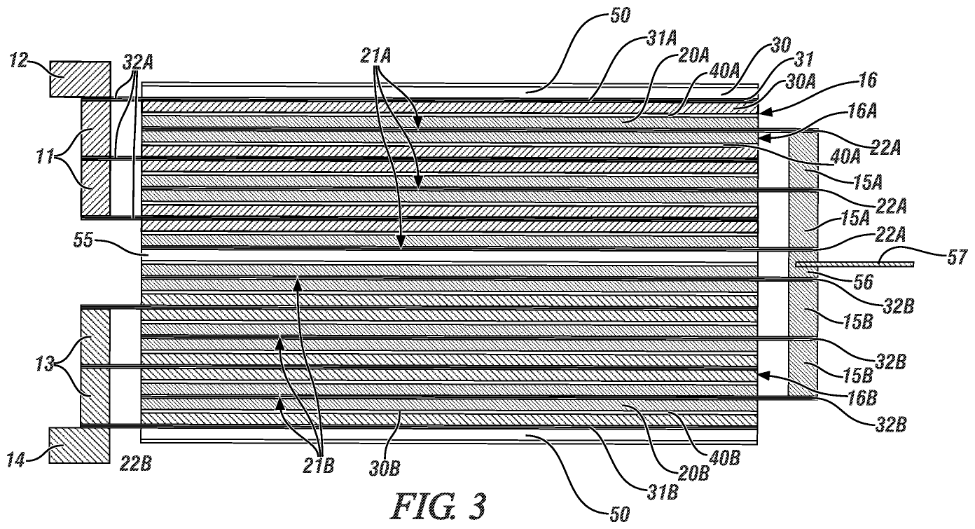

FIG. 1 schematically shows a three-dimensional isometric view of a battery assembly 100 that is composed of a plurality of battery cells 10. FIG. 2 schematically illustrates a top view of a single one of the battery cells 10, including an anode 20, an anode current collector 21, and a pair of anode tabs 22 that are arranged on a first end of the battery cell 10. A cathode current collector 31 is arranged on a second, opposite end of the battery cell 10. FIG. 3 schematically illustrates a cutaway end view of the battery assembly 100 that is composed of a plurality of the battery cells 10.

In one embodiment, and as illustrated, the battery cell 10 is a planar-shaped lithium ion battery cell 10 that is sealed in a flexible pouch containing an electrolytic material. Alternatively, the battery cell 10 is a planar-shaped lithium ion battery cell 10 that is contained in a sealed container 50, e.g., a sealed rectangular prism that includes an electrolytic material. In one embodiment, the electrolytic material is a solid state material. The battery cell 10 may have had a rectangular shape, or a non-rectangular shape, or another configuration. In one embodiment, a reference electrode (not shown) may be arranged between the anode 20 and the cathode 30 (illustrated with reference to FIG. 3).

A single electrode pair including an arrangement of the anode 20, solid state separator 40, and cathode 30 is illustrated for each of the battery cells 10. It is appreciated that multiple electrode pairs may be arranged and electrically connected in the sealed container 50, depending upon the specific application of the battery cell 10.

The anode 20 includes a first active material that is arranged on an anode current collector 21. The anode current collector 21 is a metallic substrate with a foil portion that extends from the first active material to form the anode tab 22.

The cathode 30 includes a second active material that is arranged on a cathode current collector 31, with the cathode current collector 31 having a foil portion that extends from the second active material to form the cathode tab 32.

The anode and cathode current collectors 21, 31 are thin metallic plate-shaped elements that contact their respective first and second active materials over an appreciable interfacial surface area. The purpose of the anode and cathode current collectors 21, 31 is to exchange free electrons with their respective first and second active materials during discharging and charging.

The anode current collector 21 is a flat, plate-shaped metallic substrate in the form of a rectangular planar sheet in one embodiment. The anode current collector 21 is fabricated from one of copper, copper alloy, stainless steel, nickel, etc., or another material that does not alloy with lithium. In one embodiment, the anode current collector 21 has a thickness at or near 0.02 mm. The first active material may be an indium nitride layer that is applied onto one or both surfaces of the anode current collector 24.

The cathode current collector 31 is a metallic substrate in the form of a planar sheet that is fabricated from aluminum or an aluminum alloy, and has a thickness at or near 0.02 mm in one embodiment. The solid state separator 40 is arranged between the anode 20 and the cathode 30 to physically separate and electrically isolate the anode 20 from the cathode 30.

The electrolytic material that conducts lithium ions is an element of the solid state separator 40 and is exposed to each of the anode 20 and the cathode 30 to permit lithium ions to move between the anode 20 and the cathode 30. Lithium ions are stripped from the anode 20 during discharge, or from the cathode 30 during charge to give up electrons that flow through the current collectors 21, 31, respectively, through an external circuit connected either to a load or a charger, and then to the opposite current collectors (31, 21) and electrodes (30 and 20) where they reduce lithium ions as they are being intercalated or plated.

The anode 20 and the cathode 30 are each fabricated as electrode materials that are able to deposit and strip the lithium ions (on an anode), or intercalate and de-intercalate (on a cathode). The electrode materials of the anode 20 and the cathode 30 are formulated to store lithium at different electrochemical potentials relative to a common reference electrode, e.g., lithium. The anode 20 stores deposited or plated lithium at a lower electrochemical potential (i.e., a higher energy state) than the cathode 30 such that an electrochemical potential difference exists between the anode 20 and the cathode 30 when the anode 20 is lithiated. The electrochemical potential difference for each battery cell 10 results in a charging voltage in the range of 3Vdc to 5Vdc and nominal open circuit voltage in the range of 2.9Vdc to 4.2Vdc. These attributes of the anode 20 and the cathode 30 permit the reversible transfer of lithium ions between the anode 20 and the cathode 30 either spontaneously (discharge phase) or through the application of an external voltage (charge phase) during operational cycling. The thickness of the anode 20 ranges between 10 microns (um) and 60 um in one embodiment.

The solid state separator 40 includes a solid polymer that includes electrolytic material, and may be composed of a variety of polymers that provide thermal stability. The polymer layer(s) function to electrically insulate and physically separate the anode 20 and the cathode 30. The solid state separator 40 may further be infiltrated with electrolytic material throughout the porosity of the polymer layer(s). The electrolytic material includes lithium in one embodiment. The solid state separator 40 has a thickness that may be between 10 microns (um) to 60 um.

The concepts described herein provide for a novel arrangement for anode and cathode layers to be stacked in series and parallel configurations within a battery cell to achieve a nominal potential for the battery cell that is in a range of 5.0Vdc to 8.4Vdc DC in one embodiment. This may include, in one embodiment, using a solid state electrolyte to avoid internal ionic and electric internal connections to short or discharge electrode pairs. Strategic placement of collector internal leads facilitates welding of one half of the anode collectors to one half of the cathode collectors, with the anode and cathode collectors having tabs on the same side or on opposite sides with routing of internal leads. In one embodiment, two types of anode coated current collectors and cathode coated current collectors may be utilized. Furthermore, the use of an internal intermediate layer 55 that is ionically and electronically isolating prevents occurrence of an internal self-discharge event. This intermediate layer 55 overlays the anode current collectors and cathode current collectors and advantageously has a surface area that is slightly larger than the adjacent anode current collectors and cathode current collectors. This arrangement serves to reduce the risk of ionic connectivity within the battery assembly 100. The use of a series connection lead enables balancing of internal layers similar to balancing cells in pack/module. This may further include isolation in coated domains with overlap, folded, or coated leads. In one embodiment, the isolation layer may be removed in favor of bipolar current collector between series groups.

In one embodiment, the intermediate layer 55 is an electrical isolation layer.

In one embodiment, the intermediate layer 55 is a bipolar layer composed as an electrically conductive common current collector layer, with anode and cathode coated on opposite sides. This permits electrical current to flow directly from anode to cathode through the common current collector along its thickness in a bipolar arrangement. This arrangement may improve the energy density and power capability of the cells compared to a baseline design.

Referring again to FIG. 3, the battery assembly 100 includes a plurality of battery cells 10 and an intermediate layer 55 that are arranged in a stack 16. The stack 16 includes a first subset 16A of the plurality of battery cells 10 and a second subset 16B of the plurality of battery cells 10. The intermediate layer 55 is interposed between the first subset 16A of the plurality of battery cells 10 and the second subset 16B of the plurality of battery cells 10. The first subset 16A of the plurality of battery cells 10 is joined and electrically connected to the second subset 16B of the plurality of battery cells 10 at a junction 56, which includes electrical tab 57, which is accessible for cell balancing.

Each of the plurality of battery cells 10 of the first subset 16A of the plurality of battery cells 10 includes a first cathode 30A, a first cathode current collector 31A, a first cathode tab 32A, a first anode 20A, a first anode current collector 21A, a first anode tab 22A, and a first solid state separator 40A.

Each of the plurality of battery cells 10 of the second subset 16B of the plurality of battery cells 10 includes a second cathode 30B, a second cathode current collector 31B, a second cathode tab 32B, a second anode 20B, a second anode current collector 21B, a second anode tab 22B, and a second solid state separator 40B.

The first cathode current collectors 31A of the first subset 16A of the plurality of battery cells 10 are electrically connected in parallel via the first cathode tabs 32A and welds 11 to a first terminal 12.

The second anode current collectors 21B of the second subset 16B of the plurality of battery cells 10 are electrically connected in parallel via the second anode tabs 22B and welds 13 to a second terminal 14.

The first anode current collectors 21A of the first subset 16A of the plurality of battery cells 10 are electrically connected in parallel via welds 15A, and are electrically connected to the second cathode current collectors 31B of the second subset 16B of the plurality of battery cells 10, which are electrically connected in parallel via welds 15B.

This concepts described herein provide a cell design that increases the energy density and specific energy of a solid state cell through the use of internal cell connections to raise the cell potential without exceeding a local potential difference between an anode/cathode pair that would result in an overcharge event. The internal cell connection is designed to facilitate lower heat generation compared to comparable external cell series connections.

The concepts described herein provide a battery cell arrangement in which equal quantities of anode and cathode internal electrode layers are connected to provide series internal connectivity, resulting in an elevated cell potential. The anode and cathode internal electrode layers are connected with high surface area welds to decrease heat generation, as compared to an external series cell connection. The use of the solid state electrolyte serves to avoid occurrence of internal ionic shorts and internal self-discharging. The placement of the isolating layer 55 between the series-connected electrode pairs serves to provide ionic and electronic isolation.

The placement of collector internal leads facilitates welding of one half of anode collectors to one half of cathode collectors. Same side or opposite side routing of internal leads; In pouch or stacked prismatic implementation, utilization of two types of anode coated collectors and cathode coated collectors; use of an internal “dead layer” that is ionically and electronically isolating to avoid internal self discharge with the dead layer having a slightly increased area compared to coated electrodes to further reduce the risk of ionic connectivity within the cell.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A battery assembly, comprising:
a first plurality of battery cells, a second plurality of battery cells, and an intermediate layer arranged in a stack;
wherein the intermediate layer is interposed between the first plurality of battery cells and the second plurality of battery cells;
wherein each of the first plurality of battery cells includes a first cathode, a first cathode current collector, a first anode, a first anode current collector, and a first solid state separator;
wherein each of the second plurality of battery cells includes a second cathode, a second cathode current collector, a second anode, a second anode current collector, and a second solid state separator;
wherein the first cathode current collectors of the first plurality of battery cells are electrically connected in parallel to a first terminal;
wherein the second anode current collectors of the second plurality of battery cells are electrically connected in parallel to a second terminal; and
wherein the first anode current collectors of the first plurality of battery cells are electrically connected and are electrically connected to the second cathode current collectors of the second plurality of battery cells.

2. The battery assembly of claim 1, wherein the intermediate layer ionically and electronically isolates the first plurality of battery cells from the second plurality of battery cells.

3. The battery assembly of claim 1, wherein the intermediate layer overlays the first plurality of battery cells and the second plurality of battery cells.

4. The battery assembly of claim 1, wherein the intermediate layer includes a surface area that is greater than a corresponding surface area of both the first plurality of battery cells and the second plurality of battery cells.

5. The battery assembly of claim 1, wherein the first plurality of battery cells and the second plurality of battery cells comprise pouch cells.

6. The battery assembly of claim 1, wherein the first plurality of battery cells and the second plurality of battery cells comprise prismatic cells.

7. The battery assembly of claim 1, wherein each of the first battery cells further comprises the first solid state separator having a solid state electrolyte and arranged between the first cathode and the first anode, and wherein each of the second battery cells further comprises the second solid state separator having a solid state electrolyte and arranged between the second cathode and the second anode.

8. The battery assembly of claim 1, further comprising the first solid state separator being arranged between adjacent cells of the first plurality of battery cells.

9. The battery assembly of claim 1, further comprising the first solid state separator arranged between adjacent cells of the second plurality of battery cells.

10. The battery assembly of claim 1, wherein the first anode current collectors include tab portions, and wherein the first anode current collectors are electrically connected via the tab portions.

11. The battery assembly of claim 10, wherein the tab portions are coated.

12. The battery assembly of claim 1, further comprising an enclosure, wherein the plurality of battery cells and the intermediate layer arranged in the stack are contained within the enclosure.

13. The battery assembly of claim 1, wherein the intermediate layer comprises an isolation layer.

14. The battery assembly of claim 1, wherein the intermediate layer comprises a bipolar layer that is composed as an electrically conductive common current collector layer.

15. A battery assembly, comprising:
a plurality of battery cells and an intermediate layer arranged in a stack and disposed within an enclosure;
wherein each of the plurality of battery cells includes a cathode, a cathode current collector, an anode, an anode current collector, and a solid state separator including a solid state electrolyte;
wherein the plurality of battery cells includes a first subset and a second subset;
wherein the intermediate layer is an overlayment that is interposed between the first subset and the second subset;
wherein each of the battery cells of the first subset includes a first cathode, a first cathode current collector, a first anode, a first anode current collector, and a first solid state separator;
wherein each of the battery cells of the second subset includes a second cathode, a second cathode current collector, a second anode, a second anode current collector, and a second solid state separator;
wherein the first cathode current collectors of the first subset are electrically connected in parallel to a first terminal;
wherein the second anode current collectors of the second subset are electrically connected in parallel to a second terminal; and
wherein the first anode current collectors of the first subset are electrically connected and are electrically connected to the second cathode current collectors of the second subset.

16. The battery assembly of claim 15, wherein the intermediate layer has a surface area and an outer periphery that are greater than a surface area of the plurality of battery cells to ionically and electronically isolate the first subset from the second subset.

17. The battery assembly of claim 15, wherein each of the plurality of battery cells comprises a pouch cell.

18. The battery assembly of claim 15, wherein each of the plurality of battery cells comprises a prismatic cell.

19. The battery assembly of claim 15, wherein each of the plurality of battery cells of the first subset further comprises the first solid state separator including a first solid state electrolyte arranged between the first cathode and the first anode, and wherein each of the plurality of battery cells of the second subset further comprises the second solid state separator including a second solid state electrolyte arranged between the second cathode and the second anode.

20. A method for assembling a battery, the method comprising:
arranging a plurality of battery cells and an intermediate layer in a stack;
wherein each of the plurality of battery cells includes a cathode, a cathode current collector, an anode, an anode current collector, and a solid state separator including a solid state separator;
wherein the plurality of battery cells includes a first subset and a second subset;
wherein the intermediate layer is an overlayment that is interposed between first subset and the second subset;
wherein each of the battery cells of the first subset includes a first cathode, a first cathode current collector, a first anode, a first anode current collector, and a first solid state separator;
wherein each of the battery cells of the second subset includes a second cathode, a second cathode current collector, a second anode, a second anode current collector, and a second solid state separator;
wherein the first cathode current collectors of the first subset are electrically connected in parallel to a first terminal;
wherein the second anode current collectors of the second subset are electrically connected in parallel to a second terminal; and
wherein the first anode current collectors of the first subset are electrically connected and are electrically connected to the second cathode current collectors of the second subset.
